(19) United States
(12) Patent Application Publication
(10) Pub. No.: US 2026/0027831 A1
(43) Pub. Date: Jan. 29, 2026

(54) PRINTER AND INK MIST COLLECTION METHOD

(71) Applicant: SCREEN Holdings Co., Ltd., Kyoto (JP)

(72) Inventor: Hitoshi MATSUYA, Kyoto-shi (JP)

(21) Appl. No.: 19/245,943

(22) Filed: Jun. 23, 2025

(30) Foreign Application Priority Data
Jul. 29, 2024 (JP) 2024-122101

(51) Int. Cl. B41J 2/17; B41J 2/175; B41J 29/377

(52) U.S. Cl. CPC B41J 2/1714; B41J 2/1721; B41J 2/17563; B41J 29/377

(57) ABSTRACT

The nozzle exhaust part 43 and the exhaust connector 51 (the exhaust duct 5) are separated from each other. For this reason, transmission of vibration to the nozzle exhaust part 43 from the exhaust connector 51 is suppressed. As a result, it becomes possible to suppress transmission of vibration to the ejection head 121 from the fan unit 71 which generates the suction force for collecting a mist while collecting the mist near the ejection head 121 serving as a source of the ink mist.

### CROSS REFERENCE TO RELATED APPLICATION

The disclosure of Japanese Patent Application No. 2024-122101 filed on Jul. 29, 2024 including specification, drawings and claims is incorporated herein by reference in its entirety.

### BACKGROUND

### 1. Field of the Disclosure

This disclosure relates to a technique for collecting an ink mist generated when ink is ejected onto a printing medium to print an image.

### 2. Description of the Related Art

In a printer for printing an image on a printing medium by ejecting ink from an ejection head, an ink mist is generated. Such an ink mist becomes a factor to contaminate the printing medium and the printer. Then, in JP2016-165900 and JP2016-147433, provided is a mechanism for collecting the ink mist.

### SUMMARY

It is effective to collect the ink mist near the ejection head serving as a source of the ink mist. A suction source such as a suction fan or the like which generates a suction force for collecting the mist, however, serves as a source of vibration. For this reason, the vibration generated by the suction source is transmitted to the ejection head, and there is sometimes a case where this affects ejection of ink performed by the ejection head.

This disclosure is intended to solve the above-described problem, and it is an object of this disclosure to make it possible to suppress transmission of vibration to an ejection head from a suction source which generates a suction force for collecting a mist while collecting the mist near the ejection head serving as a source of an ink mist.

A printer according to the disclosure, comprises: a printing medium transfer part transferring a printing medium in a transfer direction; an ejection head ejecting ink onto the printing medium; a collection nozzle having a nozzle intake part provided with an air intake opening facing the printing medium and a nozzle exhaust part provided with an air exhaust opening communicating with the air intake opening, being aligned with the ejection head in the transfer direction; a suction source generating a suction force; and a suction duct having a duct intake part provided with a duct opening facing the air exhaust opening of the collection nozzle, and supplying the suction force generated by the suction source to the duct opening, wherein the air exhaust opening of the nozzle exhaust part and the duct opening of the nozzle intake part face each other, and an airflow flowing into the duct opening through the air exhaust opening from the air intake opening is generated by the suction force supplied to the duct opening and a mist is sucked from the air intake opening by the airflow, and the nozzle exhaust part and the duct intake part are separated from each other.

An ink mist collection method according to the disclosure, comprises: transferring a printing medium in a transfer direction by a printing medium transfer part; ejecting ink onto the printing medium from an ejection head; and collecting the ink by a collection nozzle with a suction force supplied from a suction source through a suction duct, wherein the collection nozzle has a nozzle intake part provided with an air intake opening facing the printing medium and a nozzle exhaust part provided with an air exhaust opening communicating with the air intake opening, being aligned with the ejection head in the transfer direction, the suction duct has a duct intake part provided with a duct opening facing the air exhaust opening of the collection nozzle, and supply the suction force generated by the suction source to the duct opening, the air exhaust opening of the nozzle exhaust part and the duct opening of the duct intake part face each other, and an airflow flowing into the duct opening through the air exhaust opening from the air intake opening is generated by the suction force supplied to the duct opening and a mist is sucked from the air intake opening by the airflow, and the nozzle exhaust part and the duct intake part are separated from each other.

In the present disclosure (the printer and the ink mist collection method) having such a configuration, the collection nozzle for collecting an ink mist is provided. This collection nozzle has the nozzle intake part provided with the air intake opening and the nozzle exhaust part provided with the air exhaust opening communicating with the air intake opening. Further, the suction source and the suction duct are provided. The suction duct has the duct intake part provided with the duct opening facing the air exhaust opening of the collection nozzle. Then, the suction force generated by the suction source is supplied to the duct opening by the suction duct. As described above, the air exhaust opening of the nozzle exhaust part and the duct opening of the duct intake part face each other. For this reason, an airflow flowing into the duct opening through the air exhaust opening from the air intake opening is thereby generated by the suction force supplied to the duct opening. A mist is sucked from the air intake opening of the collection nozzle by this airflow. In other words, the collection nozzle collects an ink mist by the suction force supplied from the suction source through the suction duct. Since this collection nozzle is provided, being aligned with the ejection head, it is possible to collect the mist near the ejection head serving as a source of the ink mist. At that time, the nozzle exhaust part and the duct intake part are separated from each other. For this reason, transmission of vibration to the nozzle exhaust part from the duct intake part is suppressed. As a result, it becomes possible to suppress transmission of vibration to the ejection head from the suction source which generates the suction force for collecting a mist while collecting the mist near the ejection head serving as a source of the ink mist.

Thus, according to the present disclosure, it becomes possible to suppress transmission of the vibration from the suction source which generates the suction force for collecting the mist to the ejection head while collecting the mist near the ejection head serving as the source of the ink mist.

### BRIEF DESCRIPTION OF THE DRAWINGS

FIG. 1 is an elevational view schematically showing a printer in accordance with the present disclosure;

FIG. 2 is a view schematically showing one example of a mist collection unit included in the printer shown in FIG. 1;

FIG. 3A is a perspective view schematically showing an appearance structure of a collection nozzle;

FIG. 3B is an elevational view schematically showing the appearance structure of the collection nozzle;

FIG. 4 is a perspective view schematically showing an internal structure of the collection nozzle;

FIG. 5A is a cross-sectional view schematically showing the internal structure of the collection nozzle;

FIG. 5B is a cross-sectional view schematically showing the internal structure of the collection nozzle;

FIG. 6 is a view schematically showing an operation of the collection nozzle;

FIG. 7 is a perspective view schematically showing an exhaust connector of an exhaust duct;

FIG. 8 is a side elevational view schematically showing a mist removing part and a suction part;

FIG. 9 is a partial sectional view schematically and emphatically showing an operation performed by lifting and/or lowering an ejection head and the collection nozzle;

FIG. 10A is a view schematically showing a schematic configuration of a cabinet;

FIG. 10B is a view schematically showing a schematic configuration of the cabinet;

FIG. 11 is a perspective view schematically showing an appearance structure of a cushioning material;

FIG. 12 is a partial sectional view schematically and emphatically showing an operation performed by lifting and/or lowering the ejection head and the collection nozzle in a configuration including the cushioning material;

FIG. 13A is a cross-sectional view schematically showing a variation of the internal structure of the collection nozzle; and

FIG. 13B is a cross-sectional view schematically showing a variation of the internal structure of the collection nozzle.

### DETAILED DESCRIPTION OF THE PREFERRED EMBODIMENTS

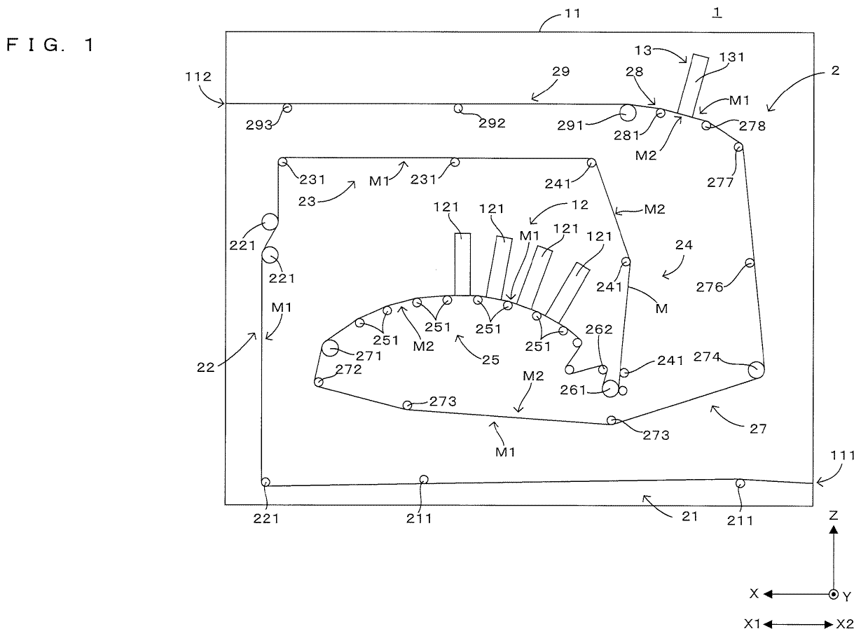

FIG. 1 is an elevational view schematically showing a printer in accordance with the present disclosure. In FIG. 1 and the following figures, an X direction which is a horizontal direction, a Y direction which is a horizontal direction orthogonal to the X direction, and a Z direction which is a vertical direction are shown as appropriate. Further, one side X1 and the other side X2 in the X direction are shown as appropriate. Herein, the one side X1 and the other side X2 face opposite to each other.

The printer 1 includes a cabinet 11, a color printing part 12 disposed inside the cabinet 11, a white printing part 13 disposed above the color printing part 12 inside the cabinet 11, and a transfer part 2 for transferring a printing medium M by using a plurality of rollers disposed inside the cabinet 11. In other words, the cabinet 11 accommodates therein the color printing part 12, the white printing part 13, and the transfer part 2.

The color printing part 12 has a plurality of (four) ejection heads 121 arranged in a traveling direction of the printing medium M (in a direction going from the other side X2 toward the one side X1) above the printing medium M transferred by the transfer part 2. The plurality of ejection heads 121 each have a nozzle facing a front surface M1 of the printing medium M passing therebelow from above, and eject color inks having different colors from the nozzles by an inkjet method. Herein, the color ink refers to ink having a color other than white, and includes inks having colors such as cyan, magenta, yellow, black, and the like. Thus, the plurality of ejection heads 121 in the color printing part 12 eject color inks, from above, onto the front surface M1 of the printing medium M passing therebelow, to thereby print a color image on the front surface M1 of the printing medium M.

Further, the white printing part 13 has a single ejection head 131 disposed above the printing medium M transferred by the transfer part 2. The ejection head 131 has a nozzle facing the front surface M1 of the printing medium M passing therebelow from above, and ejects white ink from the nozzle by an inkjet method. Thus, the ejection head 131 in the white printing part 13 ejects white ink, from above, onto the front surface M1 of the printing medium M passing therebelow, to thereby print a white image on the front surface M1 of the printing medium M.

A loading port 111 is opened in a side wall of the cabinet 11 on the other side X2, and the printing medium M is loaded into the cabinet 11 from the loading port 111. On the other hand, the transfer part 2 has a loading part 21. The loading part 21 has a plurality of rollers 211 arranged in the X direction below the color printing part 12, and the printing medium M loaded from loading port 111 is transferred from the other side X2 toward the one side X1 while being supported by the plurality of rollers 211.

Further, the transfer part 2 has an upward transfer part 22 provided on the one side X1 of the loading part 21. The upward transfer part 22 has a plurality of rollers 221 arranged in the Z direction on the one side X1 of the color printing part 12. This upward transfer part 22 folds the printing medium M having transferred by the loading part 21 upward by the roller 221 positioned at a lower end among the plurality of rollers 221, to thereby change the traveling direction of the printing medium M upward from the one side X1, and then transfers the printing medium M upward while supporting the printing medium M by the plurality of rollers 221. Thus, the printing medium M is transferred by the upward transfer part 22 from the lower side toward the upper side of the color printing part 12.

Furthermore, the transfer part 2 has an upper transfer part 23 provided above the color printing part 12. The upper transfer part 23 has a plurality of rollers 231 arranged in the X direction above the color printing part 12. This upper transfer part 23 folds the printing medium M having transferred from the upward transfer part 22 toward the other side X2 by the roller 231 positioned at an end of the one side X1 among the plurality of rollers 231, to thereby change the traveling direction of the printing medium M from the upper side toward the other side X2, and then transfers the printing medium M toward the other side X2 while supporting the printing medium M by the plurality of rollers 231.

Further, the transfer part 2 has a downward transfer part 24 provided on the other side X2 of the upper transfer part 23. The downward transfer part 24 has a plurality of rollers 241 arranged in the Z direction on the other side X2 of the color printing part 12. This downward transfer part 24 folds the printing medium M having transferred from the upper transfer part 23 downward by the roller 241 positioned at an upper end among the plurality of rollers 241, to thereby change the traveling direction of the printing medium M downward from the other side X2, and then transfers the printing medium M downward while supporting the printing medium M by the plurality of rollers 241. The roller 241 at the upper end among the plurality of rollers 241 included in this downward transfer part 24 is positioned above each of the ejection heads 121 in the color printing part 12, and the roller 241 at the lower end is positioned below each of the ejection heads 121 in the color printing part 12. In other words, the downward transfer part 24 transfers the printing medium M from the upper side toward the lower side of the color printing part 12.

Furthermore, the transfer part 2 has a color transfer part 25 provided on the one side X1 of the downward transfer part 24 below the upper transfer part 23. The color transfer part 25 has a plurality of rollers 251 arranged in the X direction, being in contact with a back surface M2 of the printing medium M, and the printing medium M having transferred from the downward transfer part 24 is supported below the color printing part 12 by the plurality of rollers 251. Thus, the plurality of rollers 251 of the color transfer part 25 are in contact with the back surface M2 of the printing medium M having transferred from the downward transfer part 24 from below, to thereby transfer the printing medium M from the other side X2 toward the one side X1 while supporting the printing medium M from below. Then, the ejection heads 121 in the color printing part 12 eject color inks from above onto the front surface M1 of the printing medium M transferred along the front surface M1 by the color transfer part 25.

At that time, the front surface M1 of the printing medium M transferred by the color transfer part 25 faces upward and the back surface M2 of the printing medium M faces downward. In more detail, the printing medium M is loaded from the loading port 111 with the front surface M1 thereof facing upward and transferred by the loading part 21 from the other side X2 toward the one side X1. The printing medium M passing through the loading part 21 is inverted front to back by the upward transfer part 22 and the upper transfer part 23 and transferred by the upper transfer part 23 from the one side X1 toward the other side X2. For this reason, the front surface M1 of the printing medium M transferred by the upper transfer part 23 faces downward. The printing medium M passing through the upper transfer part 23 is inverted front to back by the downward transfer part 24 and the color transfer part 25 and transferred by the color transfer part 25 from the other side X2 toward the one side X1. For this reason, the front surface M1 of the printing medium M transferred by the color transfer part 25 faces upward.

Further, the transfer part 2 has rollers 261 and 262, being in contact with the printing medium M on the upstream side of the color transfer part 25 in the traveling direction of the printing medium M. The roller 261 is a driving roller for driving the printing medium M.

Furthermore, the transfer part 2 has an inversion transfer part 27 for inverting the printing medium M front to back twice, which is transferred from the color transfer part 25 to the one side X1. This inversion transfer part 27 has a plurality of rollers 271 and 272 arranged in the Z direction on the one side X1 of the color transfer part 25, being in contact with the back surface M2 of the printing medium M. Among the plurality of rollers 271 and 272, the roller 271 at the upper end is a driving roller for driving the printing medium M. This roller 271 folds the printing medium M having transferred from the color transfer part 25 downward, to thereby change the traveling direction of the printing medium M downward from the one side X1. Further, the roller 272 at the lower end folds the printing medium M having transferred from the roller 271 toward the other side X2, to thereby change the traveling direction of the printing medium M from the lower side toward other side X2. Thus, the printing medium M is inverted front to back by the rollers 271 and 272, being in contact with the back surface M2 of the printing medium M, and the back surface M2 of the printing medium M thereby faces upward and the front surface M1 of the printing medium M faces downward.

Further, the inversion transfer part 27 has a plurality of rollers 273 arranged in the X direction on the other side X2 of the roller 272 below the color transfer part 25, being in contact with the back surface M2 of the printing medium M. These rollers 273 transfer the printing medium M having transferred from the roller 272, from the one side X1 toward the other side X2. Thus, the printing medium M with the back surface M2 facing upward is transferred from the one side X1 toward the other side X2 by the plurality of rollers 273, being in contact with the back surface M2 of the printing medium M.

Furthermore, the inversion transfer part 27 has a plurality of rollers 274, 276, and 277 arranged in the Z direction on the other side X2 of the plurality of rollers 273 and the downward transfer part 24, being in contact with the back surface M2 of the printing medium M. Among the plurality of rollers 274 to 277, the roller 274 at the lower end folds the printing medium M having transferred from the plurality of rollers 273 upward, to thereby change the traveling direction of the printing medium M upward from the other side X2, and the roller 277 at the upper end folds the printing medium M having transferred from the roller 274 via the roller 276 toward the one side X1, to thereby change the traveling direction of the printing medium M from the upper side toward one side X1. Thus, the printing medium M is inverted front to back by the rollers 274 to 277, being in contact with the back surface M2 of the printing medium M, and the front surface M1 of the printing medium M thereby faces upward and the back surface M2 of the printing medium M faces downward.

Further, the inversion transfer part 27 has a roller 278 disposed on the one side X1 of the roller 277 above the upper transfer part 23, being in contact with the back surface M2 of the printing medium M. The roller 278 transfers the printing medium M having transferred from the roller 277 from the other side X2 toward the one side X1. Thus, the printing medium M with the front surface M1 thereof facing upward is transferred from the other side X2 toward the one side X1 by the roller 278, being in contact with the back surface M2 of the printing medium M.

Thus, the inversion transfer part 27 transfers the printing medium M having transferred from the color transfer part 25 downward by the rollers 271 and 272 and further transfers the printing medium M with the traveling direction thereof changed toward the other side X2 by the roller 272, to thereby invert the front surface M1 and the back surface M2 of the printing medium M front to back. Subsequently, the inversion transfer part 27 transfers the printing medium M from the one side X1 toward the other side X2 by the plurality of rollers 273 and then transfers the printing medium M upward by the rollers 274 to 277. Further, the inversion transfer part 27 changes the traveling direction of the printing medium M by the roller 277 toward the one side X1, to thereby invert the front surface M1 and the back surface M2 of the printing medium M front to back again and transfer the printing medium M from the other side X2 toward the one side X1 by the roller 278.

Thus, the inversion transfer part 27 inverts the front surface M1 and the back surface M2 of the printing medium M front to back twice by using only the rollers 271 to 278 rotating while being in contact with the back surface M2 of the printing medium M and wound with the back surface M2 of the printing medium M. In other words, the inversion transfer part 27 can invert the front surface M1 and the back surface M2 of the printing medium M front to back twice without providing any support member such a roller or an air turn bar on the side of the front surface M1 of the printing medium M.

Further, the transfer part 2 has a white transfer part 28 provided on the one side X1 relative to the roller 278 of the inversion transfer part 27 above the upper transfer part 23. This white transfer part 28 has a roller 281, and the printing medium M having transferred from the roller 278 of the inversion transfer part 27 is supported below the white printing part 13 by the roller 281. Thus, the roller 281 of the white transfer part 28 is in contact with the back surface M2 of the printing medium M having transferred from the roller 278 of the inversion transfer part 27 from below, to thereby transfer the printing medium M from the other side X2 toward the one side X1 while supporting the printing medium M from below. Then, the ejection head 131 of the white printing part 13 ejects white ink, from above, onto the front surface M1 of the printing medium M having transferred along the front surface M1 thereof by the white transfer part 28.

Furthermore, the transfer part 2 has an unloading part 29 provided on the one side X1 of the white transfer part 28 above the upper transfer part 23. This unloading part 29 has a plurality of rollers 291, 292, and 293 arranged in the X direction, being in contact with the back surface M2 of the printing medium M. The roller 291 is a driving roller for driving the printing medium M, and the rollers 292 and 293 rotate, accompanying the transfer of the printing medium M. On the other hand, an unloading port 112 is opened in a side wall of the cabinet 11 on the one side X1, and the plurality of rollers 291 to 293 of the unloading part 29 transfer the printing medium M from the other side X2 toward the one side X1 while being in contact with the back surface M2 of the printing medium M from below, to thereby unload the printing medium M from the unloading port 112.

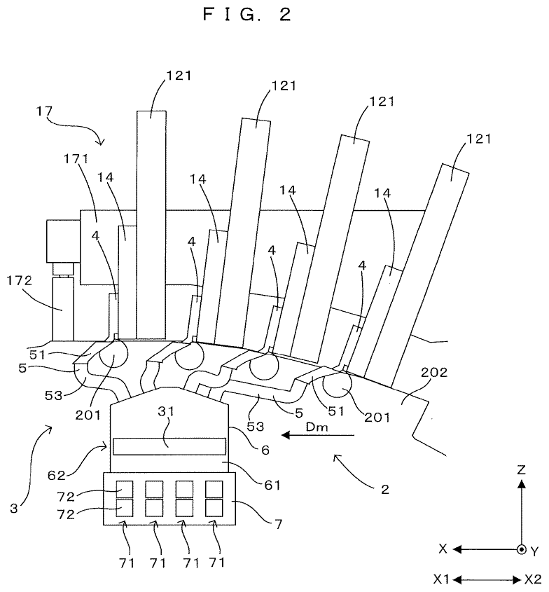

In the above-described printer 1, the transfer part 2 transfers the printing medium M in a path shown in FIG. 1 by the plurality of rollers. On the printing medium M transferred by the transfer part 2, the color printing part 12 ejects color ink to print a color image (color image printing), and the white printing part 13 ejects white ink to print a white image (white image printing). In such a printer 1, part of the color ink ejected from each of the ejection heads 121 of the color printing part 12 spatters as an ink mist. Further, part of the white ink ejected from the ejection head 131 of the white printing part 13 spatters as an ink mist. Then, the printer 1 includes a mist collection unit 3 (see FIG. 2) for collecting the ink mist. Furthermore, hereinafter, description will be made, centering on the mist collection unit 3 for the color printing part 12, but a mist collection unit 3 may be provided also for the white printing part 13, like that for the color printing part 12.

FIG. 2 is a view schematically showing one example of the mist collection unit included in the printer shown in FIG. 1. Further, in FIG. 2, each of the rollers included in the transfer part 2 is generally referred to as a “roller 201”. Furthermore, in FIG. 2, one support plate 202 among a pair of support plates 202 included in the transfer part 2 is shown. In other words, the transfer part 2 has a pair of support plates 202 disposed with a space left therebetween in the Y direction. The rollers 201 are arranged in parallel with the Y direction between the pair of support plates 202 and rotatably supported by the pair of support plates 202. By this transfer part 2, the printing medium M is transferred in a transfer direction Dm.

The mist collection unit 3 has a collection nozzle 4 disposed above the printing medium M supported by the transfer part 2. In the mist collection unit 3, particularly, a plurality of collection nozzles 4 are provided corresponding to the plurality of ejection heads 121, respectively, and each of the plurality of collection nozzles 4 is disposed on a downstream side of the corresponding ejection head 121 in the transfer direction Dm. A base frame 14 is disposed between the collection nozzle 4 and the ejection head 121 corresponding to the collection nozzle 4, and the collection nozzle 4 is fixed to the corresponding ejection head 121 by the base frame 14.

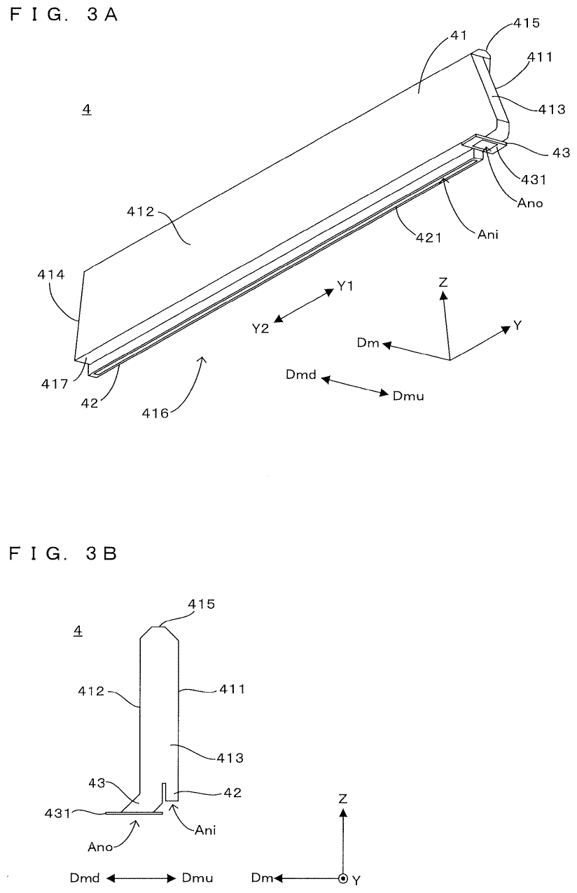

FIG. 3A is a perspective view schematically showing an appearance structure of the collection nozzle, and FIG. 3B is an elevational view schematically showing the appearance structure of the collection nozzle. In FIG. 3A, one side Y1 and the other side Y2 in the Y direction, and a downstream side Dmd and an upstream side Dmu in the transfer direction Dm are shown. Herein, the one side Y1 and the other side Y2 face opposite to each other, and the downstream side Dmd and the upstream side Dmu face opposite to each other. Further, as shown in FIG. 2, the mist collection unit 3 has the plurality of collection nozzles 4 having different tilts, and these collection nozzles 4 have a common configuration except a difference of the tilt. Then, in FIGS. 3A and 3B, description will be made, taking the mist collection unit 3 disposed in parallel with the Z direction as an example.

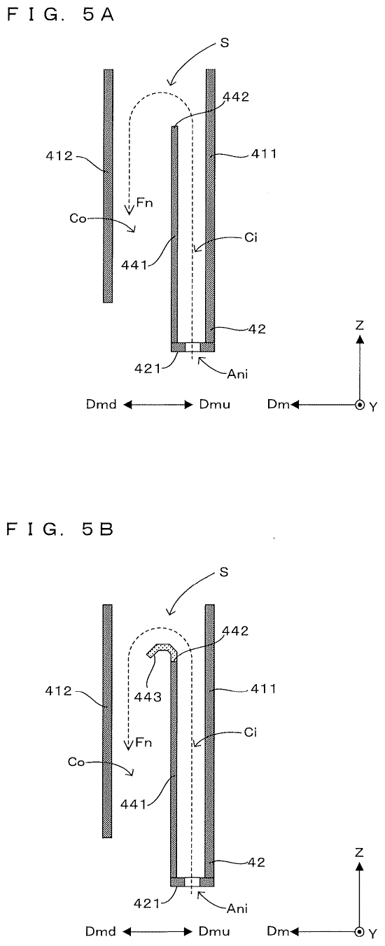

The collection nozzle 4 has a nozzle housing 41 having a long length in the Y direction, and inside the nozzle housing 41, provided is a flow path space S (see FIGS. 5A and 5B) which is a path of air. The nozzle housing 41 has a side cover 411 and a side cover 412 which are provided with a space left therebetween in the transfer direction Dm. The side cover 411 stands in parallel with the Z direction on the upstream side Dmu relative to the side cover 412 (in other words, on the side of the corresponding ejection head 121). The side cover 412 stands in parallel with the Z direction on the downstream side Dmd relative to the side cover 411 (in other words, on the opposite side of the corresponding ejection head 121).

Further, the nozzle housing 41 has a side cover 413 and a side cover 414 which are provided with a space left therebetween in the Y direction. The side cover 413 is extended in the Z direction, being inclined in the Z direction on the one side Y1 relative to the side cover 414. The side cover 414 stands in parallel with the Z direction on the other side Y2 relative to the side cover 413. The side covers 411, 412, 413, and 414 surround the flow path space S inside the nozzle housing 41 from the side (from the horizontal direction). Further, the side cover 411 has a top cover 415 which is so provided as to connect respective upper ends of the side covers 411, 412, 413, and 414. This top cover 415 covers the flow path space S surrounded by the side covers 411, 412, 413, and 414 from above.

On a bottom 416 of the nozzle housing 41, provided is a bottom cover 417 extended in the Y direction. The bottom cover 417 is so provided horizontally as to connect the side covers 412 and 414. In other words, the side cover 412 stands upward from an end of the bottom cover 417 on the downstream side Dmd, and the side cover 414 stands upward from an end of the bottom cover 417 on the other side Y2. This bottom cover 417 is extended from a lower end of the side cover 412 toward the upstream side Dmu and faces an end portion of the flow path space S inside the nozzle housing 41 on the upstream side Dmu, from below.

Further, the nozzle housing 41 has a nozzle intake part 42 protruding downward from the bottom cover 417 on the bottom 416 of the nozzle housing 41. The nozzle intake part 42 is so extended in the Y direction as to be adjoined to the bottom cover 417 from the upstream side Dmu. The nozzle intake part 42 is provided between the bottom cover 417 and the side cover 411 in the transfer direction Dm. This nozzle intake part 42 faces the flow path space S from below on the upstream side Dmu relative to the bottom cover 417 and the downstream side Dmd relative to the side cover 411. In a bottom plate 421 provided at a lower end of the nozzle intake part 42, an air intake opening Ani extended in the Y direction is opened downward. The air intake opening Ani faces the front surface M1 of the printing medium M from above, which is supported by the roller 201 of the transfer part 2. This air intake opening Ani communicates with the flow path space S inside the nozzle housing 41.

Furthermore, the nozzle housing 41 has a nozzle exhaust part 43 protruding downward from the bottom 416. The nozzle exhaust part 43 is provided on the downstream side Dmd relative to the nozzle intake part 42 and on the one side Y1 relative to the bottom cover 417. This nozzle exhaust part 43 is outside the printing medium M supported by the roller 201 of the transfer part 2, to the one side Y1 in the Y direction, and does not face the printing medium M. In the lower end of this nozzle exhaust part 43, an air exhaust opening Ano is opened downward. This air exhaust opening Ano communicates with the flow path space S inside the nozzle housing 41. Further, in the lower end of the nozzle exhaust part 43, a flange 431 is so provided as to surround the air exhaust opening Ano.

As described above, the collection nozzle 4 has the air intake opening Ani facing the printing medium M from above and the air exhaust opening Ano provided outside the printing medium M in the Y direction. Then, the air intake opening Ani and the air exhaust opening Ano are communicate with each other through the flow path space S inside the nozzle housing 41. Therefore, when the air exhaust opening Ano is sucked as described later, formed is an airflow Fn (see FIGS. 5A and 5B) reaching the air exhaust opening Ano from the air intake opening Ani through the flow path space S.

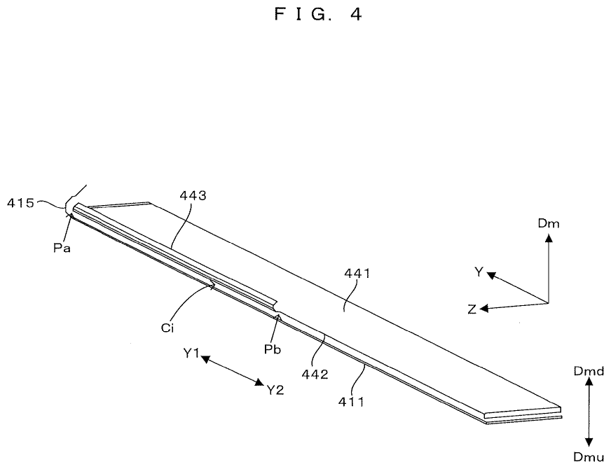

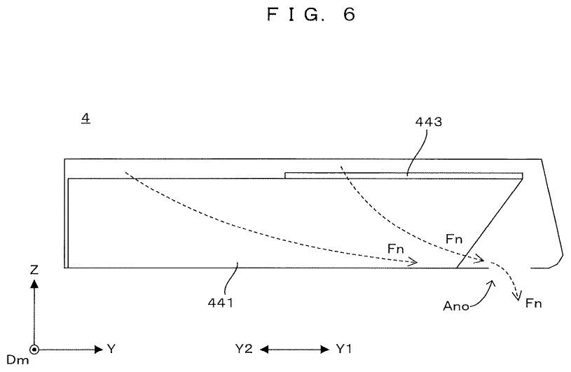

FIG. 4 is a perspective view schematically showing an internal structure of the collection nozzle, FIGS. 5A and 5B are cross-sectional views each schematically showing the internal structure of the collection nozzle, and FIG. 6 is a view schematically showing an operation of the collection nozzle. The collection nozzle 4 has a barrier rib 441 disposed in the flow path space S. The barrier rib 441 is provided between the side cover 411 and the side cover 412 in the transfer direction Dm and extended in the Z direction. The barrier rib 441 faces the side cover 411 from the downstream side Dmd and faces the side cover 412 from the upstream side Dmu.

The barrier rib 441 and the side cover 411 stand in the X direction from both ends of the bottom 421 of the nozzle intake part 42 in the transfer direction Dm, respectively, and a lower end portion of the barrier rib 441 forms a side wall of the nozzle intake part 42 on the downstream side Dmd and a lower end portion of the side cover 411 forms a side wall of the nozzle intake part 42 on the upstream side Dmu. In the transfer direction Dm, a clearance Ci is formed between the side cover 411 and the barrier rib 441, and the air intake opening Ani faces the clearance Ci from below, to thereby communicates therewith. Further, in the transfer direction Dm, a clearance Co is formed between the side cover 412 and the barrier rib 441. The clearances Ci and Co communicate with each other on the upper side relative to the barrier rib 441. Furthermore, the nozzle exhaust part 43 is connected to an end portion of the clearance Co on the one side Y1, and the clearance Co and the air exhaust opening Ano thereby communicate with each other. Therefore, the airflow Fn reaches the air exhaust opening Ano from the air intake opening Ani passing through the clearance Ci and the clearance Co in this order.

Further, the collection nozzle 4 has a baffle 443 (see FIGS. 4 and 5B) provided at an upper end 442 of the barrier rib 441. The baffle 443 protrudes toward the downstream side Dmd while bending upward from the upper end 442 of the barrier rib 441. In other words, the baffle 443 protrudes into the clearance Co from the barrier rib 441. This baffle 443 is provided one-sidedly on the side of the air exhaust opening Ano (on the one side Y1) with respect to the upper end of the barrier rib 441. In other words, the baffle 443 is provided in a range between a position Pa and a position Pb in the Y direction at the upper end 442 of the barrier rib 441. Herein, the position Pa is a position at an end on the one side Y1 of the upper end 442 of the barrier rib 441, and the position Pb is a position (an intermediate position in this exemplary case) between an end on the one side Y1 and an end on the other side Y2 of the upper end 442 of the barrier rib 441. Therefore, in a range (see FIG. 5A) in which no baffle 443 is provided, the airflow Fn going from the clearance Ci toward the clearance Co is not particularly limited. On the other hand, in a range (see FIG. 5B) in which the baffle 443 is provided, the airflow Fn going from the clearance Ci toward the clearance Co is limited by the baffle 443. As a result, as shown in FIG. 6, in the range near the air exhaust opening Ano in the Y direction, the airflow Fn is limited by the baffle 443, and in the range far away from the air exhaust opening Ano in the Y direction, the airflow Fn is not limited by the baffle 443. By providing such a baffle 443, it is possible to suppress a variation of a suction force in the Y direction, which is supplied to the air intake opening Ani.

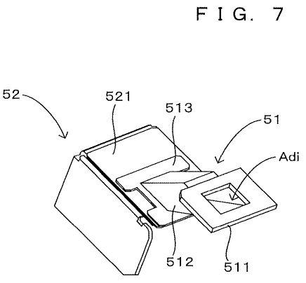

Further, as shown in FIG. 2, the mist collection unit 3 has a plurality of exhaust ducts 5 corresponding to the plurality of collection nozzles 4, and each of the plurality of exhaust ducts 5 is connected to the corresponding collection nozzle 4. The exhaust duct 5 has a an exhaust connector 51 (see FIG. 7) connected to the flange 431 of the corresponding collection nozzle 4.

FIG. 7 is a perspective view schematically showing the exhaust connector of the exhaust duct. The exhaust connector 51 has a flange 511 facing the flange 431 of the collection nozzle 4 from below. Further, the exhaust connector 51 has a duct opening Adi which is opened upward in the flange 511. In other words, the flange 511 is so provided as to protrude sideward from the duct opening Adi. Furthermore, the exhaust connector 51 has a connector pipe 512 extended downward from the flange 511, and the connector pipe 512 communicates with the duct opening Adi. The connector pipe 512 is extended, being so inclined as to go toward the one side X1 in the X direction as it goes downward. Further, the exhaust connector 51 has a flange 513 provided at a lower end of the connector pipe 512. At least the flange 513 among the flange 511 at an upper end of the exhaust duct 5 and the flange 513 at the lower end thereof is positioned below the printing medium M supported by the rollers 201 of the transfer part 2.

Furthermore, the exhaust duct 5 has a stay 52 for attaching the exhaust connector 51 to the support plate 202 of the transfer part 2. The stay 52 is attached to the support plate 202 directly or with an anti-vibration rubber, a beam or the like therebetween. This stay 52 has an attachment plate 521 supported horizontally. The flange 513 of the exhaust connector 51 comes into contact with the attachment plate 521 of the stay 52 from above and is fastened to the attachment plate 521 with a screw or the like. Thus, the exhaust connector 51 of the exhaust duct 5 is attached to the support plate 202 of the transfer part 2 with the stay 52 interposed therebetween.

Further, the exhaust duct 5 has an exhaust pipe 53 (see FIG. 2) attached to the lower end of the connector pipe 512. The exhaust pipe 53 is disposed below the printing medium M supported by the rollers 201 of the transfer part 2. In the attachment plate 521, a through hole which is opened to the connector pipe 512 is provided, and an upper end of the exhaust pipe 53 is attached to the lower end of the connector pipe 512 from below through the through hole. Thus, the exhaust pipe 53 is extended downward from the lower end of the connector pipe 512. This exhaust pipe 53 communicates with the duct opening Adi with the connector pipe 512 interposed therebetween.

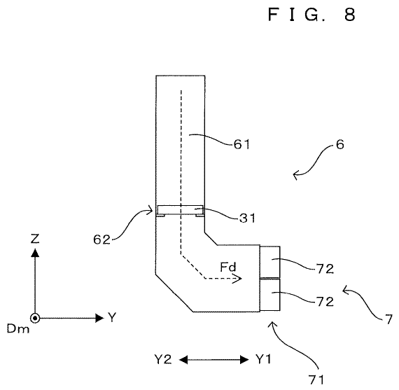

Further, as shown in FIG. 8, the mist collection unit 3 has a mist removing part 6 and a suction part 7. FIG. 8 is a side elevational view schematically showing the mist removing part and the suction part. The mist removing part 6 and the suction part 7 are disposed below the printing medium M supported by the rollers 201 of the transfer part 2 and face the printing medium M from below.

Each of the plurality of exhaust ducts 5 is connected to the suction part 7 through the mist removing part 6. Specifically, a lower end of the exhaust pipe 53 in each of the plurality of exhaust ducts 5 is connected to the mist removing part 6. The mist removing part 6 has a mist removing pipe 61 connecting a lower end of the exhaust duct 5 to the suction part 7 and a filter attachment part 62 provided for the mist removing pipe 61, and the filter 31 is detachable/attachable from the one side Y1 in the Y direction from/to the filter attachment part 62. The filter attachment part 62 is, for example, a projection protruding inward inside the mist removing pipe 61, and the filter 31 can be attached to the filter attachment part 62 by placing the filter 31 on this projection. Further, though one mist removing pipe 61 and one filter 31 are provided common to the plurality of exhaust ducts 5 herein, one mist removing pipe 61 and one filter 31 may be provided individually for each of the plurality of exhaust ducts 5.

Furthermore, the suction part 7 has a plurality of fan units 71 corresponding to the plurality of exhaust ducts 5, respectively, and each of the plurality of exhaust ducts 5 is connected to the corresponding fan unit 71 by the mist removing pipe 61. Each fan unit 71 has two suction fans 72, and a suction force for sucking air from the mist removing pipe 61 is generated by the two suction fans 72.

When this fan unit 71 starts and the suction fans 72 rotate, the airflow Fd reaching the suction part 7 from the duct opening Adi through the connector pipe 512, the exhaust pipe 53, and the mist removing pipe 61 is generated and the duct opening Adi is sucked by this airflow Fd. Thus, the suction force generated by the fan unit 71 is supplied to the duct opening Adi through the mist removing pipe 61, the exhaust pipe 53, and the connector pipe 512. As described above, the air exhaust opening Ano faces the duct opening Adi from above. Therefore, the air exhaust opening Ano is sucked by the suction force supplied to the duct opening Adi, and the airflow Fn (see FIGS. 5A and 5B) reaching the air exhaust opening Ano from the air intake opening Ani through the flow path space S is thereby formed. As a result, the ink mist sucked from the air intake opening Ani is carried by the airflow Fn to reach the duct opening Adi. Further, the ink mist reaching the duct opening Adi goes from the duct opening Adi toward the fan unit 71, being carried by the airflow Fd. Furthermore, at some midpoint of the airflow Fd going from the duct opening Adi toward the fan unit 71, the filter 31 is present. Therefore, the ink mist carried by the airflow Fd is removed from the airflow Fd by the filter 31.

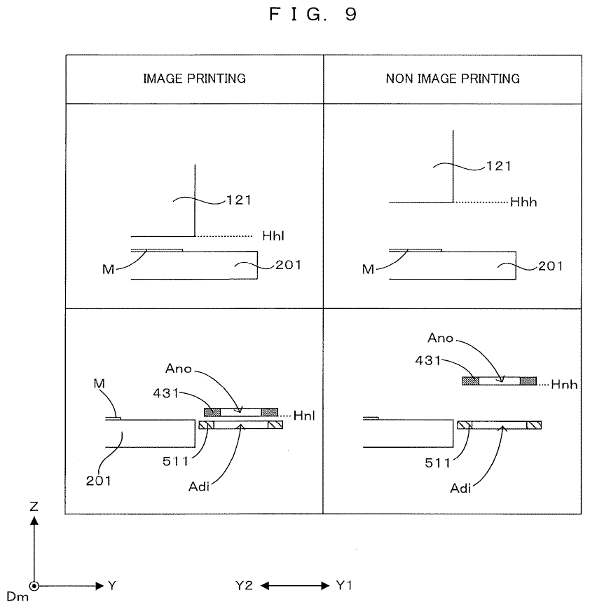

Further, the printer 1 includes a lifting/lowering driving mechanism 17 for lifting and lowering the base frame 14 which fixes the collection nozzle 4 to the ejection head 121. This lifting/lowering driving mechanism 17 has a lifting/lowering plate 171 attached to the base frame 14 and an actuator 172 for lifting and lowering the lifting/lowering plate 171. Then, when the actuator 172 lifts the lifting/lowering plate 171, the lifting/lowering plate 171 is lifted together with the ejection head 121 and the collection nozzle 4. Further, when the actuator 172 lowers the lifting/lowering plate 171, the lifting/lowering plate 171 is lowered together with the ejection head 121 and the collection nozzle 4. As a result, the operation shown in FIG. 9 is performed.

FIG. 9 is a partial sectional view schematically and emphatically showing an operation performed by lifting and/or lowering the ejection head and the collection nozzle. As shown in FIG. 9, the ejection head 121 is driven in the Z direction by the actuator 172 between a print height Hhl and a non-print height Hhh higher than the print height Hhl (in other words, farther from the printing medium M). Further, the flange 431 is driven in the Z direction by the actuator 172 between a proximity height Hnl and a separation height Hnh higher than the proximity height Hnl (in other words, farther from the flange 511).

In image printing in which the ejection head 121 ejects color ink onto the printing medium M to print a color image, the actuator 172 lowers the ejection head 121 and the collection nozzle 4. As a result, as shown in the column of “IMAGE PRINTING” of FIG. 9, the ejection head 121 is positioned at the print height Hhl, and ejects ink onto the printing medium M while facing the printing medium M supported by the roller 201 from above. In this image printing, the flange 431 of the collection nozzle 4 is positioned at the proximity height Hnl and faces the flange 511 from above. The air exhaust opening Ano thereby faces the duct opening Adi at the proximity height Hnl. Further, the suction part 7 operates the suction fans 72 of the fan unit 71 to make the suction fans 72 generate the suction force. At that time, the flange 431 positioned at the proximity height Hnl and the flange 511 are separated from each other and there is a clearance left therebetween in the Z direction. For this reason, there is a clearance left also between the air exhaust opening Ano positioned at the proximity height Hnl and the duct opening Adi in the Z direction. Since this clearance is very small, however, the suction force supplied to the duct opening Adi by the suction part 7 is sufficiently transmitted to the air exhaust opening Ano, to thereby generate the above-described airflow Fn. As a result, the ink mist generated in the image printing is collected to the filter 31 from the air intake opening Ani of the collection nozzle 4 by the airflow Fn and the airflow Fd.

In non-image printing in which the ejection head 121 does not perform the color image printing, the actuator 172 lifts the ejection head 121 and the collection nozzle 4. As a result, as shown in the column of “NON IMAGE PRINTING” of FIG. 9, the ejection head 121 is positioned at the non-print height Hhh and separated upward from the printing medium M supported by the roller 201. In this non-image printing, the flange 431 of the collection nozzle 4 is positioned at the separation height Hnh and separated upward from the flange 511.

In the embodiment described above, the collection nozzle 4 for collecting an ink mist is provided. This collection nozzle 4 has the nozzle intake part 42 provided with the air intake opening Ani and the nozzle exhaust part 43 provided with the air exhaust opening Ano communicating with the air intake opening Ani. Further, the fan unit 71 (suction source) and the exhaust duct 5 (suction duct) are provided. The exhaust duct 5 has the exhaust connector 51 (duct intake part) provided with the duct opening Adi facing the air exhaust opening Ano of the collection nozzle 4. Then, the suction force generated by the fan unit 71 is supplied to the duct opening Adi by the exhaust duct 5. As described above, the air exhaust opening Ano of the nozzle exhaust part 43 and the duct opening Adi of the exhaust connector 51 face each other. For this reason, the airflow Fn flowing into the duct opening Adi through the air exhaust opening Ano from the air intake opening Ani is thereby generated by the suction force supplied to the duct opening Adi. A mist is sucked from the air intake opening Ani of the collection nozzle 4 by this airflow Fn. In other words, the collection nozzle 4 collects the ink mist by the suction force supplied from the fan unit 71 through the exhaust duct 5. Since this collection nozzle 4 is provided, being aligned with the ejection head 121, it is possible to collect the mist near the ejection head 121 serving as a source of the ink mist. At that time, the nozzle exhaust part 43 and the exhaust connector 51 (the exhaust duct 5) are separated from each other. For this reason, transmission of vibration to the nozzle exhaust part 43 from the exhaust connector 51 is suppressed. As a result, it becomes possible to suppress transmission of vibration to the ejection head 121 from the fan unit 71 which generates the suction force for collecting a mist while collecting the mist near the ejection head 121 serving as a source of the ink mist.

Further, the collection nozzle 4 is fixed to the ejection head 121. In such a configuration, it is possible to collect the ink mist by the collection nozzle 4 near the ejection head 121 while holding a positional relation of the collection nozzle 4 with respect to the ejection head 121.

Furthermore, the lifting/lowering driving mechanism 17 (head driving part) for moving the ejection head 121 between the print height Hhl (print position) and the non-print height Hhh (non-print position) farther away from the printing medium M than the print height Hhl is provided. The ejection head 121 performs image printing for ejecting ink onto the printing medium M to thereby print an image in a state where the ejection head 121 is positioned at the print height Hhl, and on the other hand, the ejection head 121 does not perform the image printing in a state where the ejection head 121 is positioned at the non-print height Hhh. Further, the collection nozzle 4 is moved, accompanying the ejection head 121. At that time, the nozzle exhaust part 43 is positioned at the proximity height Hnl (proximity position) in the state where the ejection head 121 is positioned at the print height Hhl, and on the other hand, the nozzle exhaust part 43 is positioned at the separation height Hnh (separation position) farther away from the exhaust connector 51 (duct intake part) than the proximity height Hnl in the state where the ejection head 121 is positioned at the non-print height Hhh. Then, the fan unit 71 generates the suction force during a time period while the image printing is performed. In other words, it is possible to configure to position the ejection head 121 at the print height Hhl in the image printing and on the other hand, to position the ejection head 121 at the non-print height Hhh farther away from the printing medium M than the print height Hhl in the non-image printing. In such a configuration, however, since the collection nozzle 4 is moved, accompanying the ejection head 121, the nozzle exhaust part 43 is separated farther away from the exhaust connector 51 in the non-image printing, as compared with in the image printing. For this reason, for example, when the air exhaust opening Ano of the nozzle exhaust part 43 is connected to the duct opening Adi of the exhaust connector 51 by a pipe, it is necessary to take measures such as to prepare flexible long pipe, and there arises a possibility of causing a loss (pressure loss) of the suction force. In contrast to this, according to this embodiment, it becomes unnecessary to take such measures.

Further, the collection nozzle 4 and the fan unit 71 (suction source) are disposed on the opposite sides to each other with respect to the printing medium M supported by the transfer part 2. In such a configuration, it is possible to dispose the fan unit 71 close to the collection nozzle 4 while effectively utilizing the opposite side of the collection nozzle 4 with respect to the printing medium M to dispose the fan unit 71.

Furthermore, the air exhaust opening Ano and the duct opening Adi face each other at the position outside the printing medium M in the Y direction (the width direction of the printing medium M) orthogonal to the transfer direction Dm. In such a configuration, it is possible to effectively utilize the outside of the printing medium M in the Y direction to face the air exhaust opening Ano and the duct opening Adi each other and thereby accurately transmit the suction force from the duct opening Adi to the air exhaust opening Ano.

Further, the exhaust duct 5 (suction duct) is fixed to the support plate 202 of the transfer part 2 (printing medium transfer part). In such a configuration, it is possible to suppress transmission of the vibration from the exhaust duct 5 to the ejection head 121.

Furthermore, the filter attachment part 62 (filter attachment part) for holding the filter 31 between the exhaust duct 5 (suction duct) and the fan unit 71 (suction source) in a detachable and attachable manner is provided. The filter 31 attached to the filter attachment part 62 removes the mist from the airflow Fd going from the duct opening Adi toward the fan unit 71. In such a configuration, it is possible to suppress contamination of the fan unit 71 with the collected ink mist.

Further, the collection nozzle 4 has the nozzle housing 41 (nozzle body) disposed on the upper side of the printing medium M. The nozzle housing 41 has the side cover 411 (first side wall) and the side cover 412 (second side wall) which are provided on both the sides of the air intake opening Ani in the transfer direction Dm, each standing on the upper side of the air intake opening Ani. The barrier rib 441 standing on the upper side of the air intake opening Ani is provided between the side cover 411 and the side cover 412 in the transfer direction Dm inside the nozzle housing 41. The air intake opening Ani is positioned between the barrier rib 441 and the side cover 411 in the transfer direction Dm. Furthermore, the air exhaust opening Ano is provided on the one side Y1 of the air intake opening Ani in the Y direction (the width direction of the printing medium). Then, the airflow Fn flowing in from the air intake opening Ani goes up to the upper end 442 of the barrier rib 441 through the clearance Ci between the side cover 411 and the barrier rib 441 and then goes down through the clearance Co between the side cover 412 and the barrier rib 441, to reach the air exhaust opening Ano. On the other hand, the collection nozzle 4 has the baffle 443 (airflow limiting part) protruding from the upper end 442 of the barrier rib 441 toward the side of the side cover 412. This baffle 443 is provided over a range from the position Pa at the end on the one side Y1 of the upper end 442 of the barrier rib 441 to the position Pb on the one side Y1 relative to the end on the other side Y2 of the upper end 442 of the barrier rib 441 in the Y direction. In such a configuration, it is possible to suppress a variation of the suction force at the air intake opening Ani in the Y direction and thereby uniformly suck the ink mist.

Further, the fan unit 71 includes the two suction fans 72. In such a configuration, it is possible to generate a great suction force.

Furthermore, a clearance is left between the flange 431 included in the nozzle exhaust part 43 and the flange 511 of the exhaust connector 51 included in the exhaust duct 5. Specifically, a clearance is left between the nozzle exhaust part 43 and the exhaust duct 5 and only gas (air) exists in the clearance therebetween (in other words, no member fills the clearance). For this reason, it is possible to suppress transmission of the vibration from the exhaust connector 51 to the nozzle exhaust part 43.

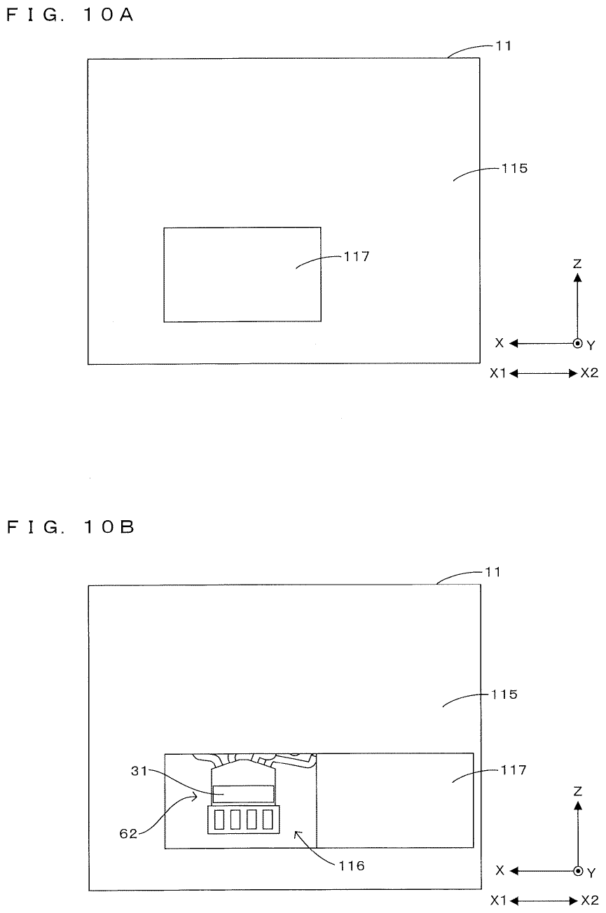

The printer 1 includes the cabinet 11 as described above. This cabinet 11 has a schematic configuration shown in FIGS. 10A and 10B. Herein, FIGS. 10A and 10B are views each schematically showing a schematic configuration of the cabinet 11. The cabinet 11 accommodates therein the constituent elements such as the transfer part 2, the plurality of ejection heads 121, the plurality of base frames 14, the lifting/lowering driving mechanism 17, and the mist collection unit 3. This cabinet 11 has a front cover 115 facing the constituent elements such as the transfer part 2, the plurality of ejection heads 121, the plurality of base frames 14, the lifting/lowering driving mechanism 17, and the mist collection unit 3 from the one side Y1. In this front cover 115, a work opening 116 is opened, and the work opening 116 faces the filter attachment part 62 from the one side Y1. Further, the front cover 115 is provided with a working door 117 which opens and closes the work opening 116. Then, when the working door 117 closes the work opening 116, the filter attachment part 62 is covered with the working door 117. On the other hand, when the working door 117 opens the work opening 116, the filter attachment part 62 is exposed to the one side Y1 through the work opening 116.

Thus, the cabinet 11 accommodating therein the transfer part 2 (printing medium transfer part), the ejection head 121, the collection nozzle 4, the suction part 7 (suction source), and the exhaust duct 5 (suction duct) is provided. This cabinet 11 is provided with the working door 117 (door) which is opened or closed by an operator, and when the working door 117 is opened, the filter attachment part 62 is exposed. In such a configuration, it is possible for the operator to easily and conveniently perform an exchange operation of the filter 31 through the work opening 116.

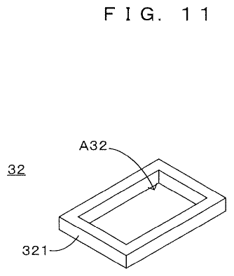

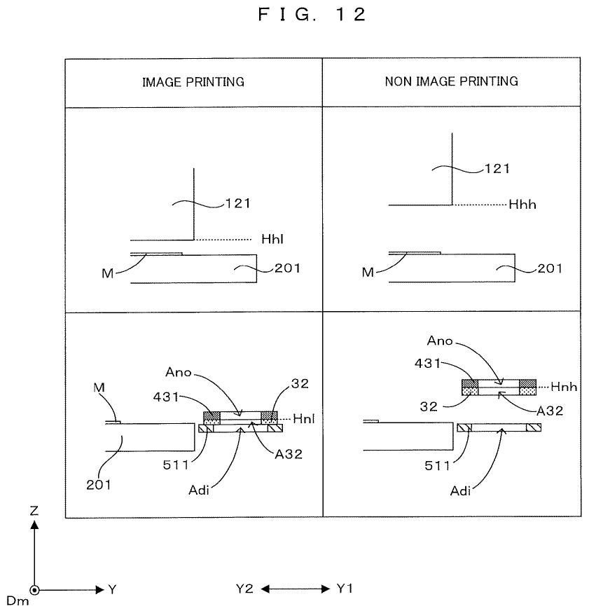

In the above-described embodiment, no particular member is provided between the flange 431 of the nozzle exhaust part 43 and the flange 511 of the exhaust connector 51. In contrast to this, the cushioning material 32 (see FIGS. 11 and 12) may be provided between these flanges.

FIG. 11 is a perspective view schematically showing an appearance structure of the cushioning material, and FIG. 12 is a partial sectional view schematically and emphatically showing an operation performed by lifting and/or lowering the ejection head and the collection nozzle in the configuration including the cushioning material. Since a difference between the exemplary operation shown in FIG. 9 and that shown in FIG. 12 lies in whether the cushioning material 32 is provided or not, description will be made, centering on the difference between these exemplary operations, and the common parts are represented by corresponding reference signs and description thereof will be omitted as appropriate.

The cushioning material 32 is formed of sponge or rubber, and includes a frame body 321 surrounding a communication opening A32 penetrating the cushioning material 32 in the Z direction. In other words, at the center of the cushioning material 32, provided is the communication opening A32. This cushioning material 32 is provided between the flange 431 and the flange 511 and bonded to a bottom surface of the flange 431. In a state where the flange 431 is positioned at the separation height Hnh in the non-image printing, the cushioning material 32 is separated upward from the flange 511.

On the other hand, in a state where the flange 431 is positioned at the proximity height Hnl in the image printing, the cushioning material 32 is in contact with an upper surface of the flange 511. Particularly, the cushioning material 32 is in contact with both the bottom surface of the flange 431 and the upper surface of the flange 511 and is crushed by the flange 431 and the flange 511, to be thereby deformed. In other words, the clearance between the flange 431 and the flange 511 is filled with the cushioning material 32. In this image printing, the communication opening A32 faces the air exhaust opening Ano from below and faces the duct opening Adi from above, and the air exhaust opening Ano and the duct opening Adi communicate with each other through the communication opening A32.

As described above, in the image printing, the suction part 7 operates the suction fans 72 of the fan unit 71, to thereby make the suction fans 72 generate the suction force. The suction force supplied to the duct opening Adi by the suction part 7 is transmitted to the air exhaust opening Ano through the communication opening A32, to thereby generate the above-described airflow Fn. As a result, the ink mist generated in the image printing is collected to the filter 31 from the air intake opening Ani of the collection nozzle 4 by the airflow Fn and the airflow Fd.

In this embodiment, the cushioning material 32 disposed between the nozzle exhaust part 43 and the exhaust connector 51 (duct intake part) to come into contact with the flange 431 of the nozzle exhaust part 43 and the flange 511 of the exhaust connector 51 is provided. This cushioning material 32 is provided with the communication opening A32 and the communication opening A32 faces the air exhaust opening Ano and duct opening Adi, to thereby cause the air exhaust opening Ano and the duct opening Adi to communicate with each other. In such a configuration, it is possible to suppress transmission of the vibration from the exhaust connector 51 to the nozzle exhaust part 43 by the cushioning material 32 while accurately transmitting the suction force from the duct opening Adi to the air exhaust opening Ano through the communication opening A32 provided in the cushioning material 32.

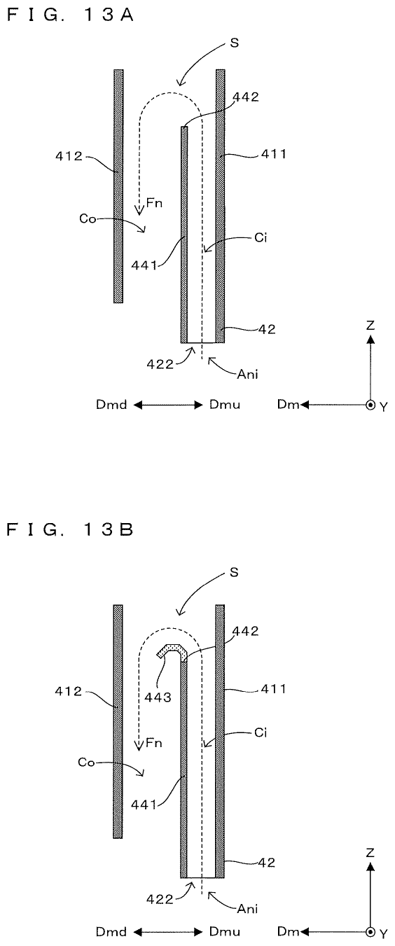

FIGS. 13A and 13B are cross-sectional views each schematically showing a variation of the internal structure of the collection nozzle. A difference from the above-described example shown in FIGS. 5A and 5B lies in that the bottom plate 421 is not provided. Then, description will be made, centering on the difference and the common parts are represented by corresponding reference signs and description thereof will be omitted as appropriate. In this variation, the barrier rib 441 and the side cover 411 each stand from both ends of a bottom 422 of the nozzle intake part 42 in the transfer direction Dm toward the Z direction, and a lower end portion of the barrier rib 441 forms a side wall of the nozzle intake part 42 on the downstream side Dmd and a lower end portion of the side cover 411 forms a side wall of the nozzle intake part 42 on the upstream side Dmu. Then, the air intake opening Ani is provided between the lower end of the side cover 411 and the lower end of the barrier rib 441. In the transfer direction Dm, the clearance Ci is formed between the side cover 411 and the barrier rib 441, and the air intake opening Ani faces the clearance Ci from below and communicates therewith.

In the above-described embodiment, the printing medium M corresponds to one example of a “printing medium” of the present disclosure, the transfer direction Dm corresponds to one example of a “transfer direction” of the present disclosure, the transfer part 2 corresponds to one example of a “printing medium transfer part” of the present disclosure, the ejection head 121 corresponds to one example of an “ejection head” of the present disclosure, the air intake opening Ani corresponds to one example of an “air intake opening” of the present disclosure, the nozzle intake part 42 corresponds to one example of a “nozzle intake part” of the present disclosure, the air exhaust opening Ano corresponds to one example of an “air exhaust opening” of the present disclosure, the nozzle exhaust part 43 corresponds to one example of a “nozzle exhaust part” of the present disclosure, the collection nozzle 4 corresponds to one example of a “collection nozzle” of the present disclosure, the fan unit 71 corresponds to one example of a “suction source” of the present disclosure, the duct opening Adi corresponds to one example of a “duct opening” of the present disclosure, the exhaust connector 51 corresponds to one example of a “duct intake part” of the present disclosure, the exhaust duct 5 corresponds to one example of a “suction duct” of the present disclosure, the printer 1 corresponds to one example of a “printer” of the present disclosure, the cushioning material 32 corresponds to one example of a “cushioning material” of the present disclosure, the communication opening A32 corresponds to one example of a “communication opening” of the present disclosure, the print height Hhl corresponds to one example of a “print position” of the present disclosure, the non-print height Hhh corresponds to one example of a “non-print position” of the present disclosure, the lifting/lowering driving mechanism 17 corresponds to one example of a “head driving part” of the present disclosure, the proximity height Hnl corresponds to one example of a “proximity position” of the present disclosure, the separation height Hnh corresponds to one example of a “separation position” of the present disclosure, the Y direction corresponds to one example of a “width direction” of the present disclosure, the filter 31 corresponds to one example of a “filter” of the present disclosure, the filter attachment part 62 corresponds to one example of a “filter attachment part” of the present disclosure, the cabinet 11 corresponds to one example of a “cabinet” of the present disclosure, the working door 117 corresponds to one example of a “door” of the present disclosure, the nozzle housing 41 corresponds to one example of a “nozzle body” of the present disclosure, the side cover 411 corresponds to one example of a “first side wall” of the present disclosure, the side cover 412 corresponds to one example of a “second side wall” of the present disclosure, the barrier rib 441 corresponds to one example of a “barrier rib” of the present disclosure, the baffle 443 corresponds to one example of a “airflow limiting part” of the present disclosure, and the suction fan 72 corresponds to one example of a “fan” of the present disclosure.

Further, the present disclosure is not limited to the above-described embodiment, but numerous modifications and variations other than those described above can be devised without departing from the scope of the disclosure. For example, a time period while the suction fan 72 operates is not limited to that for the image printing. Therefore, the suction fan 72 may be operated through the image printing and the non-image printing.

Furthermore, the number of or the arrangement of the suction fans 72 can be changed as appropriate.

Furthermore, the cushioning material 32 may be bonded to the flange 511, not to the flange 431.

Further, various materials can be used as respective materials of the flange 431 and the flange 511. Specifically, the material for these flanges may be a resin or a metal.

The present disclosure is applicable to a general technique for collecting an ink mist generated when ink is ejected onto a printing medium to print an image.

As described above, the printer may further comprises: a cushioning material disposed between the nozzle exhaust part and the duct intake part to come into contact with the nozzle exhaust part and the duct intake part, wherein the cushioning material is provided with a communication opening, and the communication opening faces the air exhaust opening and the duct opening, to thereby cause the air exhaust opening and the duct opening to communicate with each other. In such a configuration, it is possible to suppress transmission of the vibration from the duct intake part to the nozzle exhaust part by the cushioning material while accurately transmitting the suction force from the duct opening to the air exhaust opening through the communication opening provided in the cushioning material.

Further, various specific examples of the cushioning material can be considered. The cushioning material may be formed of sponge or rubber.

The printer may be configured so that the collection nozzle is fixed to the ejection head. In such a configuration, it is possible to collect the ink mist by the collection nozzle near the ejection head while holding a positional relation of the collection nozzle with respect to the ejection head.

The printer may further has: a head driving part moving the ejection head between a print position and a non-print position farther away from the printing medium than the print position, wherein the ejection head performs image printing by ejecting ink onto the printing medium to thereby print an image in a state where the ejection head is positioned at the print position, and on the other hand, the ejection head does not perform the image printing in a state where the ejection head is positioned at the non-print position, the collection nozzle is moved, accompanying the ejection head, the nozzle exhaust part is positioned at a proximity position in the state where the ejection head is positioned at the print position, and on the other hand, the nozzle exhaust part is positioned at a separation position farther away from the duct intake part than the proximity position in the state where the ejection head is positioned at the non-print position, and the suction source generates the suction force during a time period while the image printing is performed. In other words, the printer can be configured to position the ejection head at the print position in the image printing and to position the ejection head at the non-print position farther away from the printing medium than the print position in the non-image printing. In such a configuration, however, since the collection nozzle is moved, accompanying the ejection head, the nozzle exhaust part is separated farther away from the duct intake part in the non-image printing, as compared with in the image printing. For this reason, for example, when the air exhaust opening of the nozzle exhaust part is connected to the duct opening of the duct intake part, it is necessary to take measures such as to configure these parts flexibly by using long pipes, and there arises a possibility of causing a loss (pressure loss) of the suction force. In contrast to this, according to the present disclosure, it becomes unnecessary to take such measures.

The printer may be configured so that the collection nozzle and the suction source are disposed on the opposite sides to each other with respect to the printing medium. In such a configuration, it is possible to dispose the suction source close to the collection nozzle while effectively utilizing the opposite side of the collection nozzle with respect to the printing medium to dispose the suction source.

The printer may be configured so that the air exhaust opening and the duct opening face each other at a position outside the printing medium in a width direction of the printing medium, which is orthogonal to the transfer direction. In such a configuration, it is possible to effectively utilize the outside of the printing medium in the width direction to face the air exhaust opening and the duct opening each other and thereby accurately transmit the suction force from the duct opening to the air exhaust opening.

The printer may be configured so that the suction duct is fixed to the printing medium transfer part. In such a configuration, it is possible to suppress transmission of the vibration from the suction duct to the ejection head.

The printer may further has: a filter attachment part holding a filter between the suction duct and the suction source in a detachable and attachable manner, wherein the filter attached to the filter attachment part removes a mist from an airflow going from the duct opening toward the suction source. In such a configuration, it is possible to suppress contamination of the suction source with the collected ink mist.

The printer may further comprises: a cabinet accommodating therein the printing medium transfer part, the ejection head, the collection nozzle, the suction source, and the suction duct, wherein the cabinet is provided with a work opening at a position facing the filter attachment part. In such a configuration, it is possible for an operator to easily and conveniently perform a filter exchange.

The printer may be configured so that the collection nozzle has a nozzle body disposed on an upper side of the printing medium, the nozzle body has a first side wall and a second side wall which are provided on both sides of the air intake opening in the transfer direction, each standing on an upper side of the air intake opening, a barrier rib standing on the upper side of the air intake opening is provided between the first side wall and the second side wall in the transfer direction inside the nozzle body, the air intake opening is positioned between the barrier rib and the first side wall in the transfer direction, the air exhaust opening is provided on one side of the air intake opening in a width direction of the printing medium, which is orthogonal to the transfer direction, an airflow flowing in from the air intake opening goes up to an upper end of the barrier rib through between the first side wall and the barrier rib and then goes down through between the second side wall and the barrier rib, to reach the air exhaust opening, the collection nozzle has an airflow limiting part protruding from the upper end of the barrier rib toward a side of the second side wall, and the airflow limiting part is provided over a range from a position at an end on one side of the upper end of the barrier rib to a position on the one side relative to an end on the other side of the upper end of the barrier rib in the width direction. In such a configuration, it is possible to suppress a variation of the suction force at the air intake opening in the width direction and thereby uniformly suck the ink mist.

The printer may be configured so that the suction source is a fan. In such a configuration, it is possible to generate a great suction force.

The printer may be configured so that a clearance is left between the nozzle exhaust part and the duct intake part. Thus, the clearance is left therebetween and only gas (air) exists in the clearance therebetween (in other words, no member fills the clearance). For this reason, it is possible to suppress transmission of the vibration from the duct intake part to the nozzle exhaust part.

What is claimed is:

1. A printer, comprising:
a printing medium transfer part transferring a printing medium in a transfer direction;
an ejection head ejecting ink onto the printing medium;
a collection nozzle having a nozzle intake part provided with an air intake opening facing the printing medium and a nozzle exhaust part provided with an air exhaust opening communicating with the air intake opening, being aligned with the ejection head in the transfer direction;
a suction source generating a suction force; and
a suction duct having a duct intake part provided with a duct opening facing the air exhaust opening of the collection nozzle, and supplying the suction force generated by the suction source to the duct opening,
wherein the air exhaust opening of the nozzle exhaust part and the duct opening of the nozzle intake part face each other, and an airflow flowing into the duct opening through the air exhaust opening from the air intake opening is generated by the suction force supplied to the duct opening and a mist is sucked from the air intake opening by the airflow, and
the nozzle exhaust part and the duct intake part are separated from each other.

2. The printer according to claim 1, further comprising:
a cushioning material disposed between the nozzle exhaust part and the duct intake part to come into contact with the nozzle exhaust part and the duct intake part,
wherein the cushioning material is provided with a communication opening, and
the communication opening faces the air exhaust opening and the duct opening, to thereby cause the air exhaust opening and the duct opening to communicate with each other.

3. The printer according to claim 2, wherein
the cushioning material is formed of sponge or rubber.

4. The printer according to claim 1, wherein
the collection nozzle is fixed to the ejection head.

5. The printer according to claim 4, further having:
a head driving part moving the ejection head between a print position and a non-print position farther away from the printing medium than the print position,
wherein the ejection head performs image printing by ejecting ink onto the printing medium to thereby print an image in a state where the ejection head is positioned at the print position, and on the other hand, the ejection head does not perform the image printing in a state where the ejection head is positioned at the non-print position,
the collection nozzle is moved, accompanying the ejection head,
the nozzle exhaust part is positioned at a proximity position in the state where the ejection head is positioned at the print position, and on the other hand, the nozzle exhaust part is positioned at a separation position farther away from the duct intake part than the proximity position in the state where the ejection head is positioned at the non-print position, and
the suction source generates the suction force during a time period while the image printing is performed.

6. The printer according to claim 1, wherein
the collection nozzle and the suction source are disposed on the opposite sides to each other with respect to the printing medium.

7. The printer according to claim 1, wherein
the air exhaust opening and the duct opening face each other at a position outside the printing medium in a width direction of the printing medium, which is orthogonal to the transfer direction.

8. The printer according to claim 1, wherein
the suction duct is fixed to the printing medium transfer part.

9. The printer according to claim 1, further having:
a filter attachment part holding a filter between the suction duct and the suction source in a detachable and attachable manner,
wherein the filter attached to the filter attachment part removes a mist from an airflow going from the duct opening toward the suction source.

10. The printer according to claim 9, further comprising:
a cabinet accommodating therein the printing medium transfer part, the ejection head, the collection nozzle, the suction source, and the suction duct,
wherein the cabinet is provided with a work opening at a position facing the filter attachment part.

11. The printer according to claim 1, wherein
the collection nozzle has a nozzle body disposed on an upper side of the printing medium,
the nozzle body has a first side wall and a second side wall which are provided on both sides of the air intake opening in the transfer direction, each standing on an upper side of the air intake opening,
a barrier rib standing on the upper side of the air intake opening is provided between the first side wall and the second side wall in the transfer direction inside the nozzle body,
the air intake opening is positioned between the barrier rib and the first side wall in the transfer direction,
the air exhaust opening is provided on one side of the air intake opening in a width direction of the printing medium, which is orthogonal to the transfer direction,
an airflow flowing in from the air intake opening goes up to an upper end of the barrier rib through between the first side wall and the barrier rib and then goes down through between the second side wall and the barrier rib, to reach the air exhaust opening,
the collection nozzle has an airflow limiting part protruding from the upper end of the barrier rib toward a side of the second side wall, and
the airflow limiting part is provided over a range from a position at an end on one side of the upper end of the barrier rib to a position on the one side relative to an end on the other side of the upper end of the barrier rib in the width direction.

12. The printer according to claim 1, wherein
the suction source is a fan.

13. The printer according to claim 1, wherein
a clearance is left between the nozzle exhaust part and the duct intake part.

14. An ink mist collection method, comprising:
transferring a printing medium in a transfer direction by a printing medium transfer part;
ejecting ink onto the printing medium from an ejection head; and
collecting the ink by a collection nozzle with a suction force supplied from a suction source through a suction duct,
wherein the collection nozzle has a nozzle intake part provided with an air intake opening facing the printing medium and a nozzle exhaust part provided with an air exhaust opening communicating with the air intake opening, being aligned with the ejection head in the transfer direction,
the suction duct has a duct intake part provided with a duct opening facing the air exhaust opening of the collection nozzle, and supply the suction force generated by the suction source to the duct opening,
the air exhaust opening of the nozzle exhaust part and the duct opening of the duct intake part face each other, and an airflow flowing into the duct opening through the air exhaust opening from the air intake opening is generated by the suction force supplied to the duct opening and a mist is sucked from the air intake opening by the airflow, and
the nozzle exhaust part and the duct intake part are separated from each other.
